(19) United States
(12) Patent Application Publication
(10) Pub. No.: US 2023/0037545 A1
(43) Pub. Date: Feb. 9, 2023

(54) METHOD AND APPARATUS FOR DETECTING ANGULAR POSITION OF A TARGET HAVING VARIABLE TARGET FEATURES

(71) Applicant: Allegro MicroSystems, LLC, Manchester, NH (US)

(72) Inventors: Syed Bilal Ali, Heidelberg (DE); Andreas P. Friedrich, Metz-Tessy (FR); Fabian Winkler, Heidelberg (DE)

(73) Assignee: Allegro MicroSystems, LLC, Manchester, NH (US)

(21) Appl. No.: 17/393,432

(22) Filed: Aug. 4, 2021

(51) Int. Cl. G01B 7/30

(52) U.S. Cl. CPC G01B 7/30

(57) ABSTRACT

A method includes receiving a signal that is generated at least in part by one or more magnetic field sensing elements in response to a magnetic field associated with a rotating target, the rotating target a changing feature that changes with target rotation angle, the one or more magnetic field sensing elements being part of a sensor; detecting a current value of the signal; and identifying a current angular position of the rotating target relative to the sensor based on: (i) the current value of the signal and (ii) a map that maps each of a plurality of values of the signal to a different respective angular position of the rotating target.

### BACKGROUND

As is well known in the art, magnetic field sensors can be used to determine angular position or displacement. In one type of angle sensing application, for example, a magnetic field sensor is positioned in proximity to a diametrically magnetized rotating magnet. Sensing elements (such as Hall-effect elements) of the magnetic field sensor are used to generate sine and cosine signals from which the rotational angle can be determined.

### SUMMARY

According to aspects of the disclosure, a method is provided, comprising: receiving a signal that is generated at least in part by a one or more magnetic field sensing elements in response to a magnetic field associated with a rotating target, the one or more magnetic field sensing elements being part of a sensor; detecting a current peak-to-peak value of the signal; and identifying a current angular position of the rotating target relative to the sensor based on: (i) the current peak-to-peak value and (ii) a map that maps each of a plurality of peak-to-peak values of the signal to a different respective angular position of the rotating target.

According to aspects of the disclosure, a sensor is provided, comprising: one or more magnetic field sensing elements; and a processing circuitry configured to: receive a signal that is generated at least in part by the one or more magnetic field sensing elements in response to a magnetic field associated with a rotating target; detect a current peak-to-peak value of the signal; identify a current angular position of the rotating target relative to the sensor based on: (i) the current peak-to-peak value and (ii) a map that maps each of a plurality of peak-to-peak values of the signal to a different respective angular position of the rotating target; and set a value of an output signal based on the current angular position of the rotating target.

According to aspects of the disclosure, a non-transitory computer-readable medium is provided that is arranged to store one or more instructions, which, when executed by a processing circuitry, cause the processing circuitry to perform the operations of: receiving a signal that is generated at least in part by a one or more magnetic field sensing elements in response to a magnetic field associated with a rotating target, the one or more magnetic field sensing elements being part of a sensor; detecting a current peak-to-peak value of the signal; and identifying a current angular position of the rotating target relative to the sensor based on: (i) the current peak-to-peak value and (ii) a map that maps each of a plurality of peak-to-peak values of the signal to a different respective angular position of the rotating target.

According to aspects of the disclosure, a method is provided comprising: receiving a signal that is generated at least in part by a one or more magnetic field sensing elements in response to a magnetic field associated with a rotating target, the rotating target having a changing feature, the one or more magnetic field sensing elements being part of a sensor; detecting a current value of the signal; and identifying a current angular position of the rotating target relative to the sensor based on: (i) the current value of the signal and (ii) a map that maps each of a plurality of values of the signal to a different respective angular position of the rotating target.

According to aspects of the disclosure, a system is provided, comprising: one or more magnetic field sensing elements that are arranged to generate a signal in response to a magnetic field associated with the rotating target, the rotating target having a changing feature, the one or more magnetic field sensing elements being part of a sensor; and a processing circuitry configured to: receive a signal that is generated at least in part by the one or more magnetic field sensing elements in response to a magnetic field that is associated with a rotating target; detect a current value of the signal; identify a current angular position of the rotating target relative to the sensor based on: (i) the current value and (ii) a map that maps each of a plurality of values of the signal to a different respective angular position of the rotating target; and set a value of an output signal based on the current angular position of the rotating target, wherein the rotating target is arranged so that a strength of the magnetic field at a location of the sensor varies as a function of an angular position of the rotating target relative to the sensor.

### BRIEF DESCRIPTION OF THE DRAWINGS

The foregoing features may be more fully understood from the following description of the drawings in which:

FIG. 1 is a diagram of an example of a rotating target, according to aspects of the disclosure;

FIG. 2 is a diagram of an example of a system, according to aspects of the disclosure;

FIG. 3 is a diagram of an example of a sensor, according to aspects of the disclosure;

FIG. 4 is a diagram of an example of a map, according to aspects of the disclosure;

FIG. 5 is a diagram of an example of a rotating target, according to aspects of the disclosure;

FIG. 6 is a plot of an air gap size that is associated with the rotating target of FIG. 5, according to aspects of the disclosure;

FIG. 7 is a plot of a signal that is associated with the rotating target of FIG. 5, according to aspects of the disclosure;

FIG. 8 is a plot of the peak-to-peak values of the signal of FIG. 7, according to aspects of the disclosure;

FIG. 9 is a diagram of an example of a rotating target, according to aspects of the disclosure;

FIG. 10 is a plot of an air gap size that is associated with the rotating target of FIG. 9, according to aspects of the disclosure;

FIG. 11 is a plot of a signal that is associated with the rotating target of FIG. 9, according to aspects of the disclosure;

FIG. 12 is a plot of the peak-to-peak values of the signal of FIG. 11, according to aspects of the disclosure;

FIG. 13A is a plot of an example of a signal that is associated with a rotating target;

FIG. 13B is a plot of a plurality of air gap curves that are associated with the signal of FIG. 13A.

FIG. 14 is a state diagram illustrating the operation of a sensor, according to aspects of the disclosure;

FIG. 15A is a flowchart of an example of a process, according to aspects of the disclosure;

FIG. 15B is a flowchart of an example of a process, according to aspects of the disclosure; and

FIG. 16 is a diagram of an example of a processing circuitry, according to aspects of the disclosure.

### DETAILED DESCRIPTION

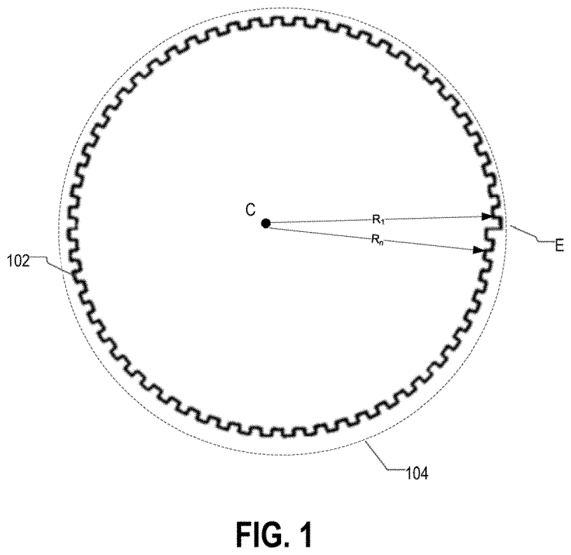

FIG. 1 is a diagram of an example of a rotating target 102, which has a variable radius R over target rotation angle. The rotating target 102 has a center C and an edge E. The rotating target may be arranged to rotate about the center C. The rotating target 102 may be round in shape and it may have a plurality of radii R, wherein each of the radii R has a different length than the rest and extends from the center C to the edge E of the rotating target 102. Shown in FIG. 1 is the radius R₁, which is the longest one among the radii R. Also shown in FIG. 1 is the radius Rₙ, which is the shortest one among the radii R. In FIG. 1, the rotating target 102 is centered with a circle 104, which has radius R₁. The circle 104 is provided to illustrate the variation of the length of the radii R.

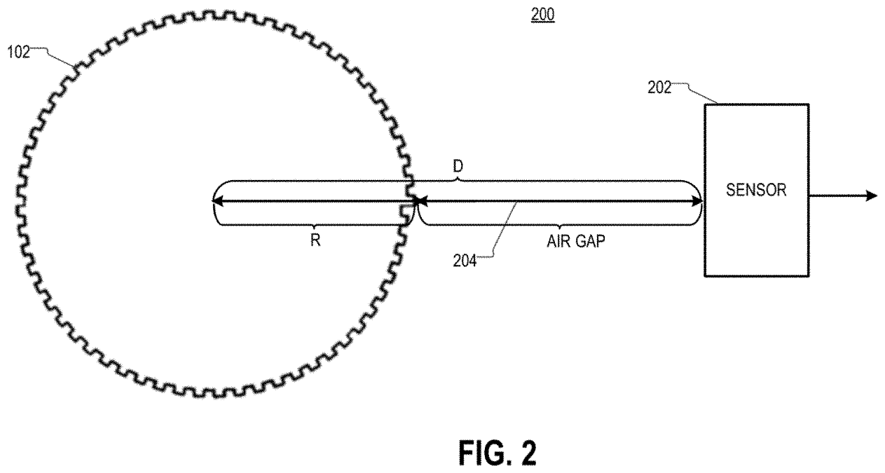

FIG. 2 is a diagram of an example of a system 200, according to aspects of the disclosure. The system includes the rotating target 102 and a sensor 202 that is spaced apart from the rotating target 102 by an air gap 204. The sensor 202 may include any suitable type of the magnetic field sensor that is configured to detect the angular position of the rotating target 102. The rotating target 102 may modulate the magnetic field that is produced by a back-bias magnet. The sensor 202 may sense the modulated magnetic field and use it to determine the angular position of the rotating target 102. Because the radius of rotating target 102 varies with target angle rotation, as the target rotates, the size of the air gap 204 will change. As the size of the air gap 204 changes, the strength of the magnetic field at the location of the sensor 202 will change, as well. As is discussed further below, the sensor 202 may take advantage of the variation of the strength of the magnetic field to identify the angular position of the rotating target 102 relative to the sensor 202. In some respect the distance D between the center of the target 102 and the sensor 102 may be equal to the sum of the air gap and the sum of the radius R of the target (at the point (or tooth) in the target 102 that is the closest to the sensor 202).

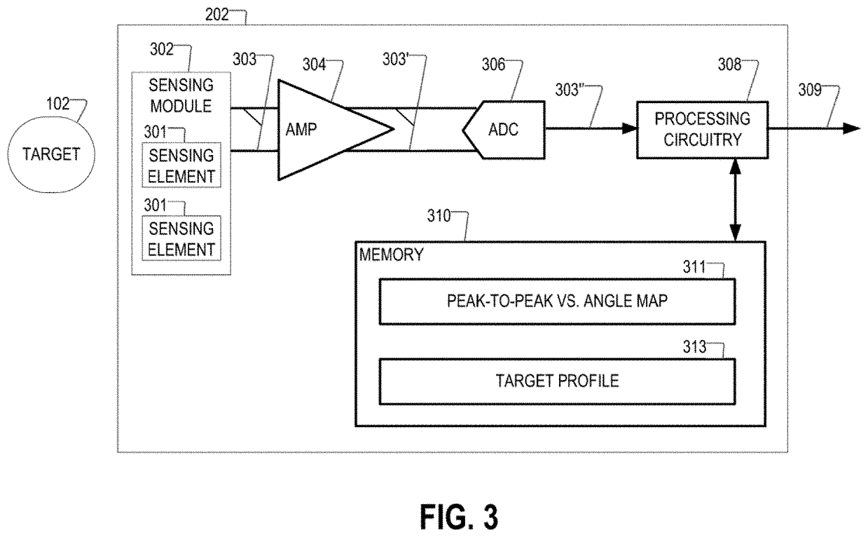

FIG. 3 is a diagram illustrating the sensor 202, according to one particular implementation. As illustrated, the sensor 202 may include a sensing module 302, an amplifier 304, an analog-to-digital converter (ADC) 306, a processing circuitry 308, and a memory 310. The sensing module 302 may include one or more magnetic field sensing elements 301. Each of the magnetic field sensing elements 301 may include one or more of a giant magnetoresistor (GMR), a tunnel magnetoresistor (TMR), a Hall element, and/or any other suitable type of magnetic field sensing element 301. Each of the magnetic field sensing elements 301 may have an axis of maximum sensitivity that is oriented to detect a magnetic field with the rotating target 102 in use. The memory 310 may include any suitable type of volatile or non-volatile memory, such as Electrically Erasable Programmable Read-Only Memory (EEPROM), random-access memory (RAM), etc. The processing circuitry may include one or more of digital logic circuitry, a general-purpose processor, a special-purpose processor, and/or any other suitable type of processing circuitry.

In operation, the sensing module 302 may generate a signal 303 in response to a magnetic field that is associated with the rotating target 102. In embodiments, Sensing elements 301 can be configured to generate a differential signal 303. As noted above, the magnetic field may include a magnetic field that is modulated by the rotating target 102. The amplifier 304 may amplify the signal 303 to produce a signal 303′. The ADC 306 may digitize the signal 303′ to produce a signal 303″. The processing circuitry 308 may process the signal 303″ to produce an output signal 309. The output signal 309 may be indicative of one or more of speed of rotation of the rotating target 102, direction of rotation of the rotating target 102, angular position of the rotating target 102, and/or any other characteristic of the position of the rotating target 102. According to the example of FIG. 3, signals 303′ and 303″ are processed (or adjusted) versions of the signal 303. For this reason, under the nomenclature of the present application, they may each be referred to as “signal 303.”

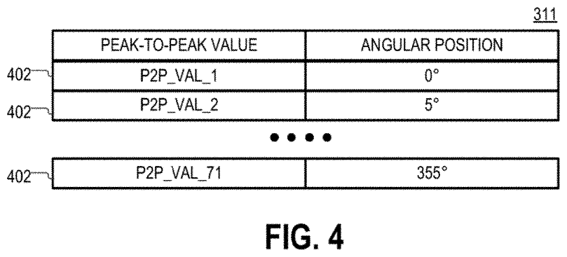

The memory 310 may be configured to store a map 311 that maps peak-to-peak values of the signal 303 to corresponding angular positions of the rotating target 102. As illustrated in FIG. 4, the map 311 include a plurality of entries 402. Each of the entries 402 may identify a particular angular position of the rotating target 102 relative to the sensor 202 and a corresponding peak-to-peak value, which the signal 303 is expected to have when the angular position is assumed by the rotating target 102. As is discussed below, a peak-to-peak value of the signal 303 may be the difference between a maximum of the signal 303 (e.g., either a local or a global maximum) and a minimum of the signal 303 (e.g., either a local or a global maximum) that occurs immediately before or immediately after the maximum.

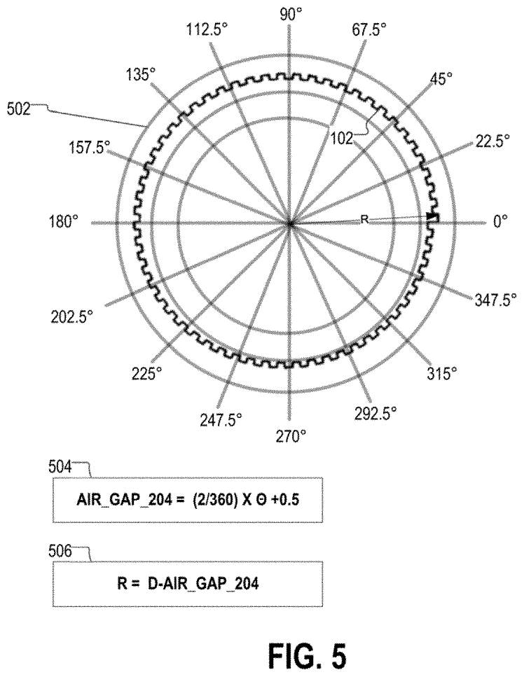

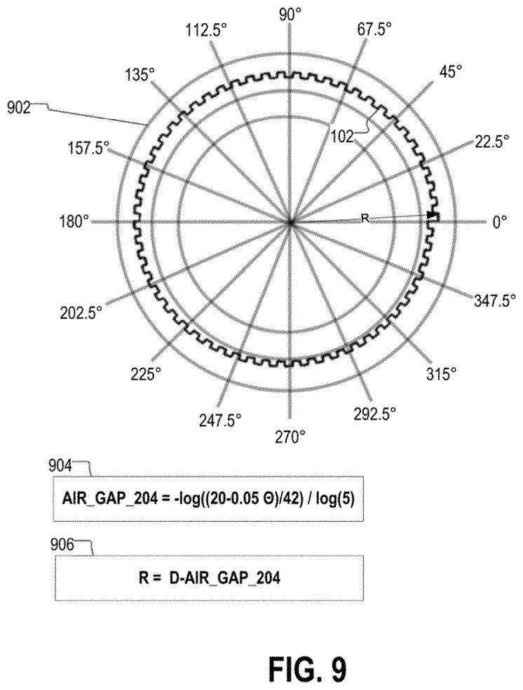

The memory 310 may further store a target profile 313. The target profile 313 may include any information about the rotating target 102 that is useable in generating the map 311. For example, the target profile 313 may include an indication of a relationship between the size of a variable feature of the rotating target 102 (e.g., radius, tooth size, tooth pitch, etc.) and an angle (or angular coordinate) that is associated with the size. In some implementations, the indication of the relationship may be the same or similar to equations 504 and 904, which are shown in FIGS. 5 and 9, respectively. However, it will be understood that the present disclosure is not limited to any type of indication of the relationship between the size of the variable feature and the angular position of the rotating target 102 being included in the target profile 313.

Although in the example of FIGS. 1-4 the target is a gear, alternative implementations are possible in which the target has 102 is a different type of object. Although in the example of FIGS. 1-4 the rotating target 102 includes a metal gear that modulates a magnetic field generate by a back bias magnet, it will be understood that alternative implementations are possible in which the target includes a permanent magnet, and/or any other suitable type of target. In some implementations, instead of using a back bias magnet, the system 200 may use a coil that is arranged to generate a magnetic field; the generated a magnetic field may induce another magnetic field in the target 102, and the sensor 202 may use the induced magnetic field to determine the angular position of the target 102.

Stated succinctly, the present disclosure is not limited to any specific type of target.

Although in the example of FIGS. 1-4, the rotating target 102 has a varying radius, alternative implementations are possible in which the target has another variable feature. For instance, in some implementations, the size of the teeth of the rotating target 102 and/or the distance between the teeth of the target may vary. Stated succinctly, the present disclosure is not limited to the rotating target 102 having any specific type of variable feature, as long as the variation in the feature causes the strength of a magnetic field associated with the rotating target 102 to vary (proportionally to the angular position of the rotating target 102) at the location where the sensor 202 is located. Although in the example of FIG. 4, the map 311 maps respective peak-to-peak values of the signal 303, alternative implementations are possible in which the map 311 maps absolute values of the signal 303 to a corresponding angular position. For example, in implementations in which the rotating target 102 does not have teeth, the map 311 may map any value of the signal 303 to a corresponding angular position.

FIGS. 5-8 are plots illustrating aspects of the operation of the system 200 (shown in FIG. 2), according to one particular implementation. In this implementation, the size of the air gap 204 is linearly proportional to the angular position of the rotating target 102

FIG. 5 shows a plot of the rotating target 102 on a polar coordinate system 502. FIG. 5 illustrates that each of the plurality of radii R of the rotating target 102 can be represented by a set of polar coordinates—i.e., by an angle coordinate and a radial coordinate. The angle coordinate of each of the plurality of radii corresponds to an angle θ between the radius and the polar axis of the polar coordinate system 502. The radial coordinate of each of the plurality of radii R corresponds to the length of the radius, and it may be expressed by equations 504 and 506, which are shown in FIG. 5. Equation 504 illustrates that the size of the air gap 203 is linearly proportional to the angular position of the target 102. Equation 506 illustrates that the radius of the target at a given angular coordinate is equal to the difference between distance D (shown in FIG. 2) and the size of the air gap 204 (at an angular position of the target 102 that is represented by the angular coordinate). Together, equations 504 and 506 illustrate that the length of each of the plurality of radii of the rotating target 102 is linearly proportional to the angle coordinate of the radius.

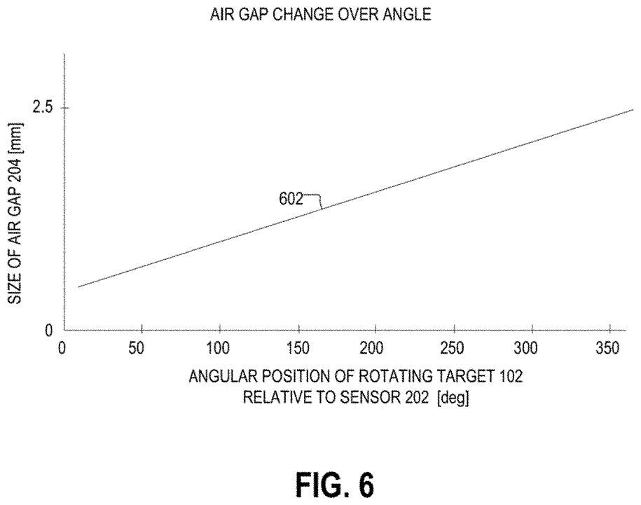

FIG. 6 is a plot of a curve 602, which represents the size of the air gap 204 as a function of the angular position of the rotating target 102 relative to the sensor 202. The curve 602 illustrates that as the angular position of the rotating target 102 changes, the air gap 204 between the rotating target 102 and the sensor 202 would also change. Furthermore, the curve 602 illustrates that each angular position of the rotating target 102 with respect to the sensor 202 (e.g., each angular position in the range 0°-360°, etc.) may be associated with a different respective size of the air gap 204. As a result of this arrangement, each angular position of the rotating target 102 with respect to the sensor 202 may be associated with a different strength of the magnetic field (associated with the rotating target 102) at the location of the sensor 202. The variability in the strength of the magnetic field at the location of the sensor 202 may in turn result in the signal 303 (shown in FIG. 3) having different respective peak-to-peak values for different angular positions of the rotating target 102. As is discussed further below, the sensor 202 may take advantage of this property of the signal 303, and use the peak-to-peak value of the signal 303 at any given time instant to determine the angular position of the rotating target 102 (relative to the sensor 202) at that time instant. As can be readily appreciated, since the rotating target 102 includes a finite number of teeth, curve 602 is an interpolation.

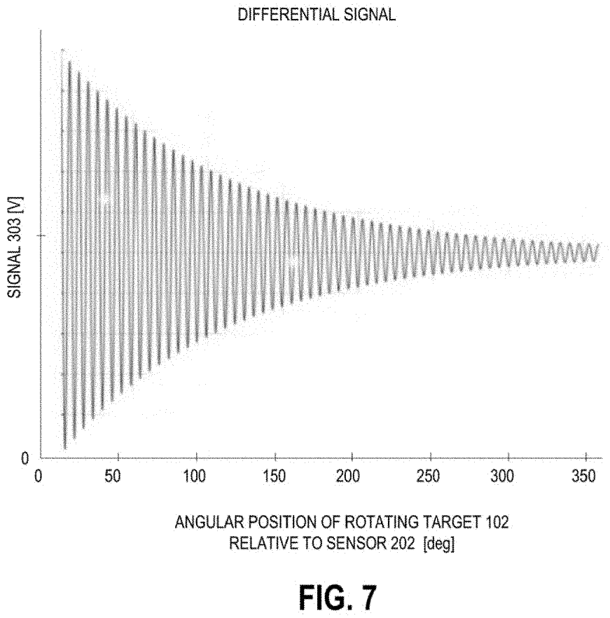

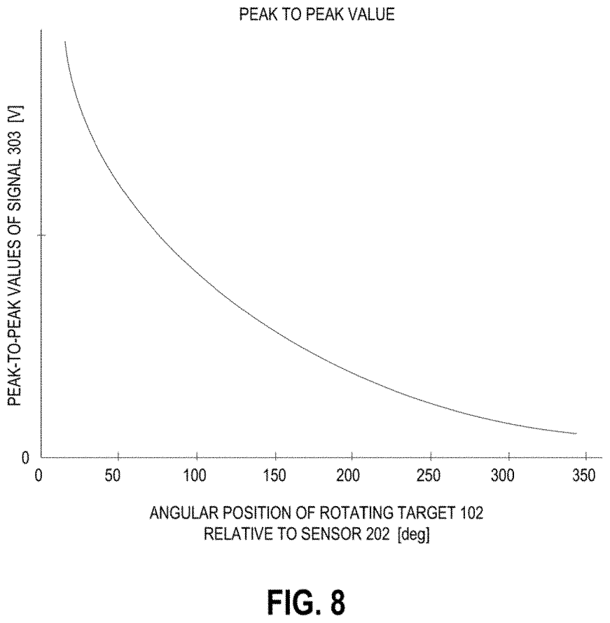

FIG. 7 is a plot of the level of the signal differential 303 versus the angular position of the rotating target 102. FIG. 8 is a plot of the peak-to-peak values of the signal 303 versus the angular position of the rotating target 102. Together, FIGS. 7-8 illustrate that when the radius R of the rotating target 102 (and/or the size of the air gap 204) is linearly proportional to the angular position of the rotating target 102 (with respect to the sensor 202), the peak-to-peak value of the signal 303 would be proportional to the inverse exponent of the angular position of the rotating target 102.

FIGS. 9-12 are plots illustrating aspects of the operation of the system 200 (shown in FIG. 2) according to one particular implementation. FIGS. 9-12 illustrate a different configuration of the rotating target 102, which causes the size of the air gap 204 to be logarithmically proportional to the angular position of the rotating target 102.

FIG. 9 shows a plot of the rotating target 102 on a polar coordinate system 902. FIG. 9 illustrates that each of the plurality of radii R of the rotating target 102 can be represented by a set of polar coordinates—i.e., by an angle coordinate and a radial coordinate. The angle coordinate of each of the plurality of radii corresponds to an angle θ between the radius and the polar axis of the polar coordinate system 902. The radial coordinate of each of the plurality of radii R corresponds to the length of the radius, and it may be expressed by equations 904 and 906, which are shown in FIG. 9. Equation 904 illustrates that the size of the air gap 203 is logarithmically proportional to the angular position of the target 102. Equation 906 illustrates that the radius of the target at a given angular coordinate is equal to the difference between distance D (shown in FIG. 2) and the size of the air gap 204 (at an angular position of the target 102 that is represented by the angular coordinate). In other words, together, equations 904 and 906 illustrate that the length of each of the plurality of radii of the rotating target 102 is logarithmically proportional to the angle coordinate of the radius.

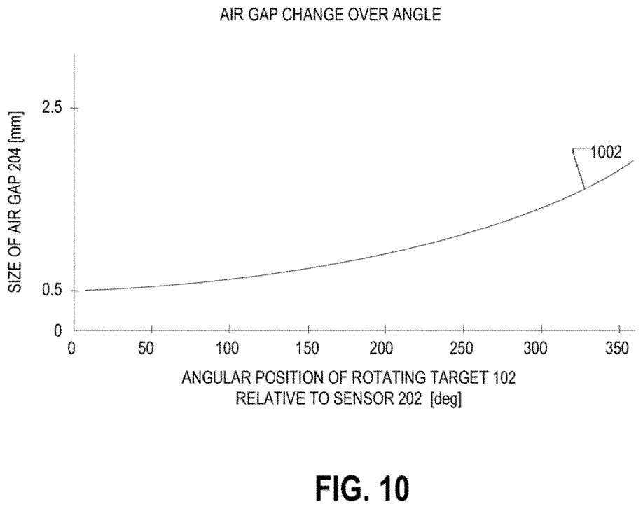

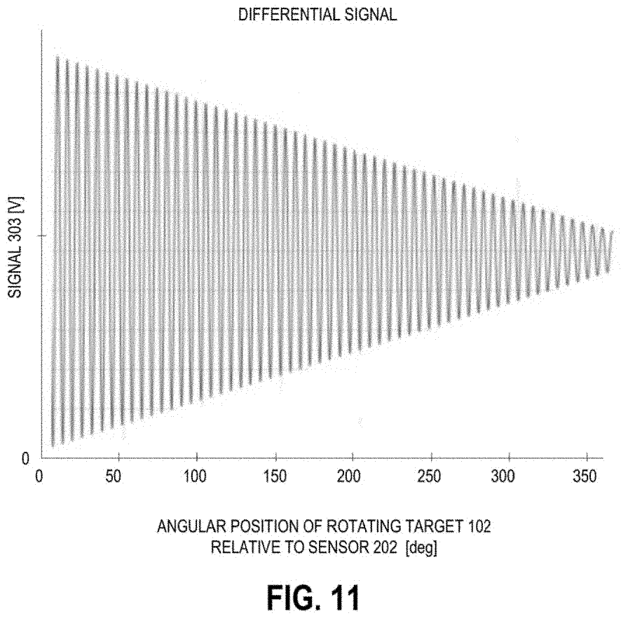

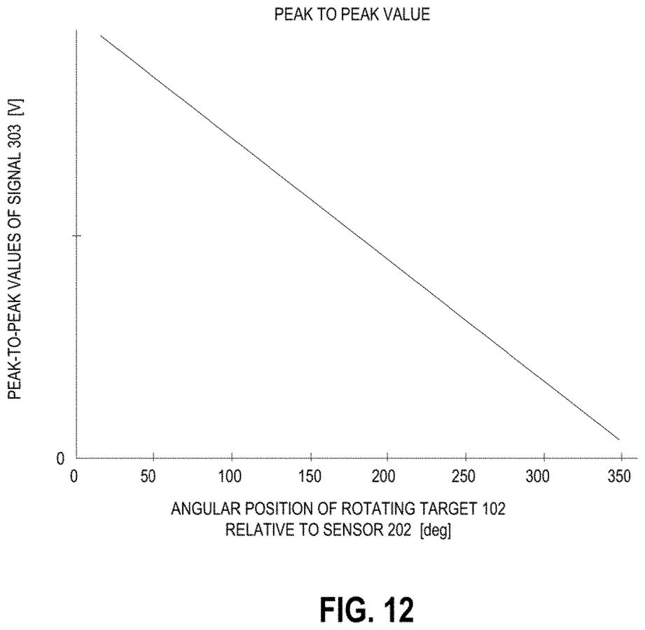

FIG. 10 is a plot of a curve 1002, which represents the size of the air gap 204 as a function of the angular position of the rotating target 102. The curve 1002 illustrates that, as the angular position of the rotating target 102 with respect to the sensor 202 changes, the air gap 204 between the rotating target 102 and the sensor 202 would also change. FIG. 11 is a plot of the level of the signal differential 303 versus the angular position of the rotating target 102. FIG. 12 is a plot of the peak-to-peak values of the signal 303 versus the angular position of the rotating target 102. Together, FIGS. 10-12 illustrate that when the radius R of the rotating target 102 (and/or the size of the air gap 204) is logarithmically proportional to the angular position of the rotating target 102 (with respect to the sensor 202), the peak-to-peak values of the signal 303 would be linearly proportional to the angular position of the rotating target 102. In some respects, making the peak-to-peak values of the signal 303 linearly proportional to the angular position of the rotating target 102 (relative to the sensor 202) is advantageous because it simplifies the mapping between different angular positions of the rotating target 102 and the respective peak-to-peak value of the signal 303.

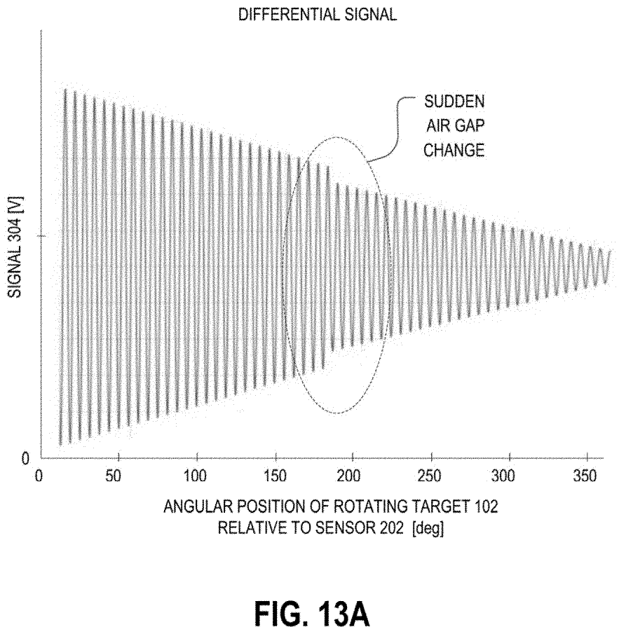

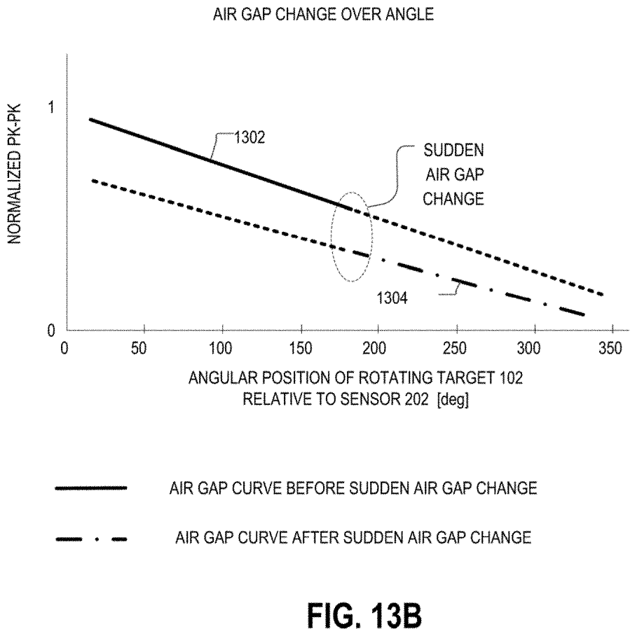

FIG. 13A shows a plot of the signal 303 when the size of the air gap 204 (shown in FIG. 2) is changed abruptly. For example, the size of the air gap 204 may be changed abruptly due to a mechanical shock or another event that falls outside of the normal operating parameters of the system 200. FIG. 13A illustrates that when the size of the air gap 204 is changed abruptly, an unexpectedly large difference between two consecutive values of the signal 303 may occur. As is discussed further below, in some implementations, the sensor 202 may detect sudden changes in the air gap, as such changes may change the mapping between the peak-to-peak values of the signal 303 and the angular position of the rotating target 102.

FIG. 13B is a plot of a curve 1302 and 1304. Curve 1302 illustrates the mapping between different peak-to-peak values of the signal 303 and the angular position of the rotating target 102 (relative to the sensor 202), before the size of the air gap 204 has changed abruptly (e.g., due to a mechanical shock, etc.). Curve 1304 illustrates the mapping between different peak-to-peak values of the signal 303 and the angular position of the rotating target 102 (relative to the sensor 202), after the size of the air gap 204 has changed abruptly (e.g., due to a mechanical shock, etc.). As noted above, the map 311 may initially be a representation of the curve 1302, and it may be used by the sensor 202 to determine the angular position of the rotating target 102 relative to the sensor 202. After the size of the air gap 204 has changed abruptly, the map 311 may no longer be usable to determine the angular position of the rotating target 102. In this regard, as is discussed further below, when a sudden change in the size of the air gap 204 is detected by the sensor 202, the sensor 202 may update map 311, effectively causing map 311 to represent the curve 1304.

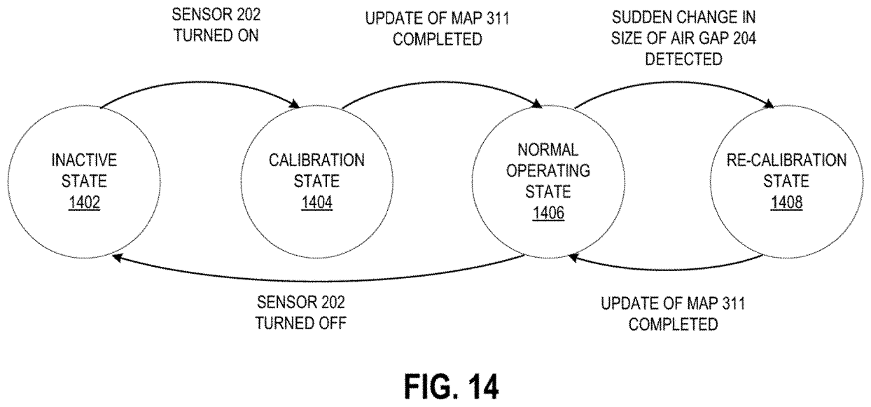

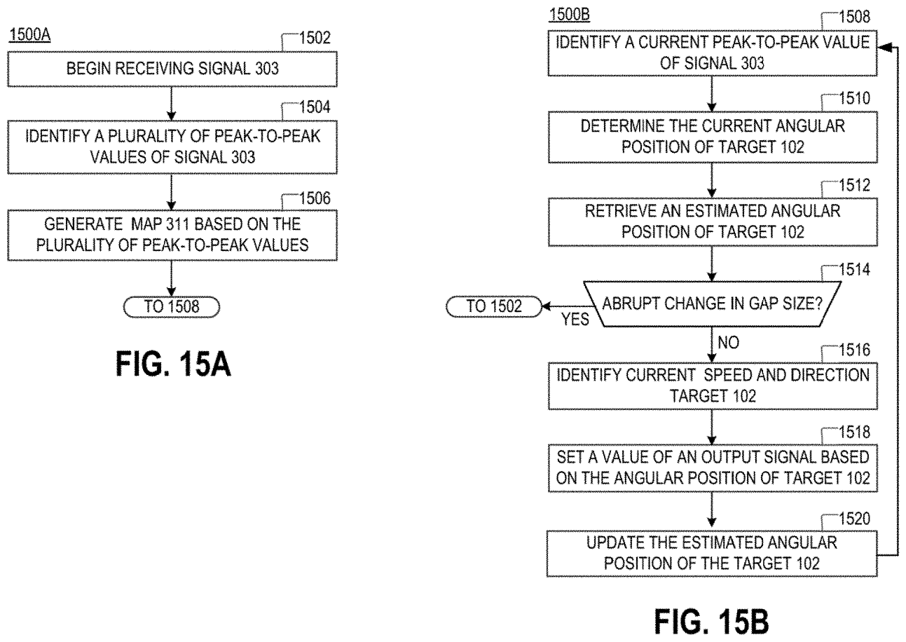

FIG. 14 is a state diagram illustrating the operation of the sensor 202. As illustrated, the sensor 202 may be in one of an inactive state 1402, a calibration state 1404, a normal operating state 1406, and a re-calibration state 1408. When the sensor 202 is in the inactive state 1402, the sensor 202 may be turned off or otherwise disabled. When the sensor 202 is in the calibration state 1404, the sensor 202 may instantiate and/or update the map 311 (shown in FIG. 3). In some implementations, when the sensor is in the calibration state 1404, the sensor 202 may execute the process 1500A, which is discussed further below with respect to FIG. 15A. When the sensor 202 is in the normal operating state 1406, the sensor may process the signal 303 to generate the output signal 309 (shown in FIG. 3). In some implementations, when the sensor 202 is in the normal operating state, the sensor 202 may execute the process 1500B, which is discussed further below with respect to FIG. 14B. When the sensor 202 is in the re-calibration state 1408, the sensor 202 may update or re-calculate the map 311. In some implementations, when the sensor 202 is in the re-calibration state, the sensor 202 may execute the process 1500A, which is discussed further below with respect to FIG. 15A.

As illustrated in FIG. 14, the sensor 202 may transition from the inactive state 1402 to the calibration state 1404 when the sensor 202 is turned on. The sensor 202 may transition from the calibration state 1404 to the normal operating state 1406 when the map 311 is updated (and/or generated). As is discussed further below, updating the map 311 may include identifying a mapping between each of a plurality of peak-to-peak values of the signal 303 and a respective angular position of the rotating target 102 relative to the sensor 202. The sensor 202 may transition out of the normal operating state 1406 and into the re-calibration state 1408 when the sensor 202 detects a sudden change in the size of air gap 204. The sensor 202 may transition from the re-calibration state 1408 into the normal operating state 1406 after the sensor 202 has completed an update to the map 311. As is discussed further below, the update may include identifying a new mapping between the peak-to-peak values of the signal 303 and different angular positions of the rotating target 102. The sensor 202 may transition from the normal operating state 1406 into the inactive state 1402 when the sensor 202 is turned off.

In the example of FIG. 14, the sensor 202 undergoes a calibration state and a re-calibration state. However, alternative implementations are possible in which the sensor 202 does not undergo a calibration state 1404 and re-calibration state 1408. In such implementations, the sensor 202 may use a factory-default version of the map 311, which is stored in the memory 310 before the sensor 202 leaves the factory. Stated succinctly, there are various ways to integrate, into the operation of the sensor 202, a map that maps peak-to-peak values to respective angular positions to determine the angular position (or speed) of a rotating target, and the present disclosure is not limited to any specific manner for integrating the map 311 into the operation of the sensor 202.

FIG. 15A is a flowchart of an example of a process 1500A, according to aspects of the disclosure. At step 1502, the processing circuitry 308 receives two or more samples of the signal 303. At step 1504, the processing circuitry 308 identifies a plurality of peak-to-peak values of the signal 303. At step 1506, the processing circuitry 308 generates and/or updates the map 311 based on the plurality of peak-to-peak values.

Generating and/or updating the map 311 may include generating a plurality of entries 402 (shown in FIG. 4) and including each of the generated entries 402 into the map 311. Each of the entries 402 may map a different peak-to-peak value to a corresponding angular position of the rotating target with respect to the sensor 202. For example, as noted above, the rotating target 102 may be configured to have at least one variable feature (e.g., radius, tooth size, tooth pitch, etc.) over target angle, which causes the signal 303 to change in a pattern in which the peak-to-peak value of the signal 303 (or actual value of the signal 303 in some implementations) at any given time instant corresponds to one and only one angular position of the rotating target. As noted above, the one-to-one mapping between angular position and peak-to-peak value may be created by configuring the rotating target 102 to produce a magnetic field whose strength varies, at the position where the sensor 202 is located, as the rotating target 102 rotates. The present disclosure is not limited to any specific manner of configuring the target to produce such an effect.

The angular position of the rotating target 102 may have a relationship to peak-to-peak values of the signal 303, which is known ahead of time, and an indication of which is stored in the target profile 313. As noted above, the relationship may be a linearly proportional relationship, a logarithmically proportional relationship, and/or any other suitable type of relationship. By using prior knowledge of the relationship (which is obtained from the target profile 313) and by observing two or more peak-to-peak values of the signal 303, the processing circuitry may determine the peak-to-peak value of the signal 303 for any desired angular position of the rotating target 102. The peak-to-peak value for any angular position of the rotating target 102 may be determined by using standard curve fitting techniques.

In the example of FIG. 15A, the map 311 includes a data structure, and generating/updating the map 311 includes creating a plurality of data structure entries, wherein each entry maps a different peak-to-peak value of the signal 303 to a corresponding angular position of the target. However, alternative implementations are possible in which the map includes either (i) an equation that specifies a relationship between angular position of the rotating target 102 and the peak-to-peak values of the signal 303 or (ii) logic for evaluating the equation. In such implementations, generating/updating the map 311 may include determining one or more coefficients that are part of the equations. By way of example, in instances in which the peak-to-peak value of the signal 303 is linearly proportional to the angular position of the target, generating/updating the map 311 may include determining the values of a slope coefficient and/or an offset coefficient.

Although in the example of FIG. 15A step 1502 involves identifying a plurality of peak-to-peak values of the signal 303, alternative implementations are possible in which a plurality of actual values of the signal 303 is identified instead as may be measured in a manufacturing setting for example. In such implementations, each of the plurality of entries 402 in the map 311 may associate a different one of the plurality of values to a respective angular position of the rotating target 102.

FIG. 15B is a flowchart of an example of a process 1500B, according to aspects of the disclosure.

At step 1508, the processing circuitry 308 identifies the current peak-to-peak value of the signal 303 based on one or more samples of the signal 303.

At step 1510, the processing circuitry 308 determines the current angular position of the rotating target 102 relative to the sensor 202 based on the current peak-to-peak value of the signal 303. In some implementations, identifying the current angular position of the rotating target 102 may include using the map 311 to map the current peak-to-peak value of the signal 303 to a corresponding angular position. In instances in which the map 311 includes a data structure, such as the data structure shown in FIG. 4, mapping the current-peak-to-peak value of the signal 303 to an angular position may include: (i) performing a search of the data structure to identify an entry (e.g., an entry 402) that corresponds to the current peak-to-peak value (and/or current value) of the signal 303, and (ii) retrieving the value of the angular position from the identified entry. In instances in which the map 311 includes an equation or logic for mapping the current peak-to-peak value to the angular position of the rotating target 102, mapping the current peak-to-peak value of the signal 303 to the angular position of the rotating target 102 may include evaluating the equation and/or executing the logic to determine the angular position.

At step 1512, the processing circuitry 308 retrieves the value of an estimated angular position of the rotating target 102 from the memory 310. The estimated angular position of the rotating target 102 may include the angular position, relative to the sensor 202, which the rotating target 102 was expected to have (prior to the most recent execution of step 1510) at the time of the most recent execution of step 1510.

At step 1514 the processing circuitry 308 detects if the size of the air gap 204 (shown in FIG. 2) has changed abruptly. More specifically, the processing circuitry 308 may determine if a difference between the estimated angular position of the target (retrieved at step 1512) and the determined angular position of the rotating target 102 (obtained at step 1510) exceeds a threshold. If the threshold is exceeded, the processing circuitry 308 determines that the air gap 204 has changed abruptly, and the process 1500B returns to step 1502 of the process 1500A. On the other hand, if the threshold is not exceeded, the processing circuitry 308 may determine that the size of the air gap 204 has not changed abruptly, and the process 1500B proceeds to step 1516. In some respects, during the first iteration of steps 1508-1520, the expected angular position may be set to a default value, which would ensure that the flow of process 1500B would proceed to step 1516 in that iteration.

At step 1516, the processing circuitry 308 identifies the speed and direction of rotation of the rotating target 102. The speed of the rotating target 102 may be identified based on the rate at which peaks occur in the signal 303. The direction of rotation of the rotating target 102 may be determined by detecting the slope of a signal representing the target angel. However, it will be understood that the present disclosure is not limited to any specific method for determining the speed and/or direction of rotation of the rotating target 102.

At step 1518, the processing circuitry 308 sets the value of the output signal 309 based on the angular position of the rotating target 102, which is determined at step 1510. In some implementations, the processing circuitry 308 may set the output signal 309 to a value that is at least in part indicative of the angular position of the rotating target 102. Additionally or alternatively, in some implementations, setting the value of the output signal 309 based on the determined angular position may include formatting the value of the determined angular position in accordance with a predetermined protocol, and/or outputting the value of the determined angular position via an output interface of the sensor 202. Although in the example of FIG. 15B the output signal 309 (which is set at step 1518) encodes only the angular position of the rotating target 102, alternative implementations are possible in which the output signal 309 also encodes the speed and/or direction of rotation of the rotating target 102.

At step 1520, and processing circuitry 308 updates the estimated angular position of the rotating target 102. Specifically, the processing circuitry estimates the angular position, which the rotating target 102 is expected to have when step 1510 is executed again. In some implementations, the processing circuitry 308 may calculate the estimated angular position of the rotating target 102 based on the current angular position of the rotating target 102, the speed of rotation of the rotating target 102, and the direction of rotation of the rotating target 102.

Although in the example of FIG. 15B, the current peak-to-peak value of the signal 303 is determined at step 1508 and subsequently used to determine the angular position of the rotating target 102, it will be understood that alternative implementations are possible in which the actual or instantaneous value of the signal 303 is determined and used to identify the angular position of the rotating target 102.

In some implementations, the sensor 202 may have a stop-and-go mode, such that if the target 102 stops at a certain angle, this angle (and/or the peak-to-peak value corresponding to the angle) is stored in the memory 310 by the processing circuitry 303. Next, the processing circuitry may calculate an expected angle based on the stored angle (or peak-to-peak value). Afterwards, when the target 102 resumes rotating, the processing circuitry 308 may compare the expected angle with a measured angle to determine whether an abrupt change in the size of the air gap 204 has occurred. If an abrupt change is detected, the processing circuitry 311 may update (or recalculate) the map 311, as discussed above with respect to step 1514.

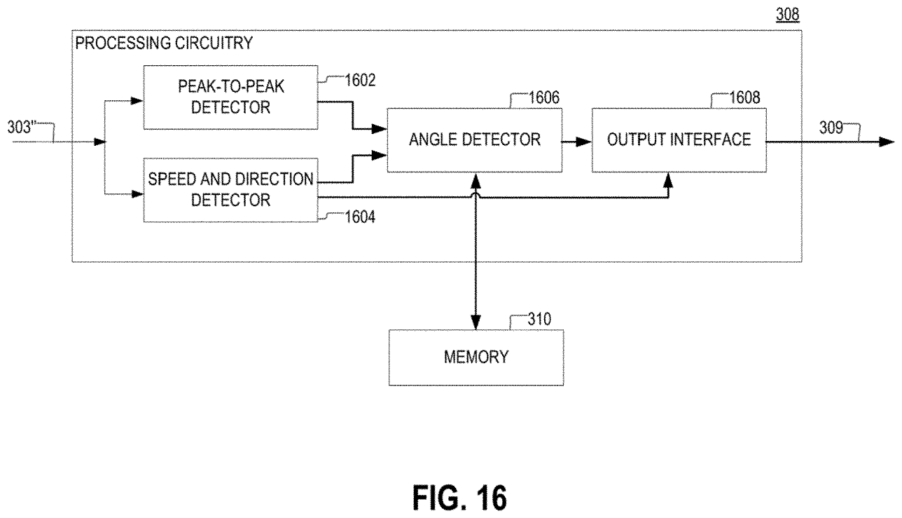

FIG. 16 is a diagram of at least a portion of the processing circuitry 308, in accordance with one implementation. As illustrated, the processing circuitry 308 may include a peak-to-peak detector 1602, a speed and direction detector 1604, an angle detector 1606, and an output interface 1608. The peak-to-peak detector 1602 may include any suitable type of electronic circuitry that is configured to detect peaks in the signal 303 (e.g., positive and/or negative peaks). In some implementations, the peak-to-peak detector 1602 may be configured to perform step 1508 of process 1500B. The speed and direction detector 1604 may include any suitable type of electronic circuitry that is configured to detect the speed and direction of rotation of the rotating target 102. By way of example, the speed and direction detector 1604 may detect the speed and direction of rotation of the rotating target 102 by detecting the rate at which peaks in the signal 303 occur, as well as detecting the slope of a signal representing the target angle, respectively. In some implementations, the speed and direction detector 1604 may be configured to perform step 1516 of process 1500B. The angle detector 1606 may include any suitable type of electronic circuitry that is configured to: (i) determine the angular position of the rotating target 102 and detect sudden changes in the size of the air gap 204. In some implementations, the angle detector may be configured to perform step 1510 of the process 1500B. The output interface 1608 may include any suitable type of electronic circuitry for outputting the output signal 309. The output interface 1608 may be configured to encode the angular position, speed, and direction of rotation of the rotating target 102. The output interface 1608 may be configured to perform step 1518 of the process 1500B.

In some respects, the techniques and systems described throughout the disclosure allow the angular position of the rotating target 102 to be determined from the rotation of one just tooth and valley. This is in contrast to other speed sensors, including crank sensors, that use a signature/index region to reset the rotation angle, and which may take up to one full rotation to find the absolute angle. In some respects, an advantage of the techniques and systems described throughout the disclosure is that they allow detection of the angular position of a target that rotates at higher speeds, and do not require the use of a permanent magnet as the target object. This renders the techniques and systems described throughout the disclosure suitable for use in applications where ferromagnetic targets are required, such as electric motor control systems and engine control systems.

The concepts and ideas described herein may be implemented, at least in part, via a computer program product, (e.g., in a non-transitory machine-readable storage medium such as, for example, a non-transitory computer-readable medium), for execution by, or to control the operation of, data processing apparatus (e.g., a programmable processor, a computer, or multiple computers). Each such program may be implemented in a high-level procedural or object-oriented programming language to work with the rest of the computer-based system. However, the programs may be implemented in assembly, machine language, or Hardware Description Language. The language may be a compiled or an interpreted language, and it may be deployed in any form, including as a stand-alone program or as a module, component, subroutine, or another unit suitable for use in a computing environment. A computer program may be deployed to be executed on one computer or multiple computers at one site or distributed across multiple sites and interconnected by a communication network. A computer program may be stored on a non-transitory machine-readable medium that is readable by a general or special purpose programmable computer for configuring and operating the computer when the non-transitory machine-readable medium is read by the computer to perform the processes described herein. For example, the processes described herein may also be implemented as a non-transitory machine-readable storage medium, configured with a computer program, where upon execution, instructions in the computer program cause the computer to operate in accordance with the processes. A non-transitory machine-readable medium may include but is not limited to a hard drive, compact disc, flash memory, non-volatile memory, or volatile memory. The term unit (e.g., an addition unit, a multiplication unit, etc.), as used throughout the disclosure may refer to hardware (e.g., an electronic circuit) that is configured to perform a function (e.g., addition or multiplication, etc.), software that is executed by at least one processor, and configured to perform the function, or a combination of hardware and software.

According to the present disclosure, a magnetic field sensing element can include one or more magnetic field sensing elements, such as Hall effect elements, magnetoresistance elements, or magnetoresistors, and can include one or more such elements of the same or different types. As is known, there are different types of Hall effect elements, for example, a planar Hall element, a vertical Hall element, and a Circular Vertical Hall (CVH) element. As is also known, there are different types of magnetoresistance elements, for example, a semiconductor magnetoresistance element such as Indium Antimonide (InSb), a giant magnetoresistance (GMR) element, for example, a spin valve, an anisotropic magnetoresistance element (AMR), a tunneling magnetoresistance (TMR) element, and a magnetic tunnel junction (MTJ). The magnetic field sensing element may be a single element or, alternatively, may include two or more magnetic field sensing elements arranged in various configurations, e.g., a half bridge or full (Wheatstone) bridge. Depending on the device type and other application requirements, the magnetic field sensing element may be a device made of a type IV semiconductor material such as Silicon (Si) or Germanium (Ge), or a type III.-V. semiconductor material like Gallium-Arsenide (GaAs) or an Indium compound, e.g., Indium-Antimonide (InSb).

Having described preferred embodiments, which serve to illustrate various concepts, structures and techniques, which are the subject of this patent, it will now become apparent that other embodiments incorporating these concepts, structures and techniques may be used. Accordingly, it is submitted that the scope of the patent should not be limited to the described embodiments but rather should be limited only by the spirit and scope of the following claims.

1. A method comprising:
receiving a signal that is generated at least in part by a one or more magnetic field sensing elements in response to a magnetic field associated with a rotating target, the one or more magnetic field sensing elements being part of a sensor;
detecting a current peak-to-peak value of the signal; and
identifying a current angular position of the rotating target relative to the sensor based on: (i) the current peak-to-peak value and (ii) a map that maps each of a plurality of peak-to-peak values of the signal to a different respective angular position of the rotating target.

2. The method of claim 1, further comprising setting a value of an output signal based on the current angular position of the rotating target.

3. The method of claim 1, wherein the map includes at least one of:
an equation that maps each of the plurality of peak-to-peak values of the signal to a different respective angular position of the rotating target,
a lookup table that maps each of the plurality of peak-to-peak values of the signal to a different respective angular position of the rotating target, or
logic that maps each of the plurality of peak-to-peak values of the signal to a different respective angular position of the rotating target.

4. The method of claim 1, wherein the rotating target is arranged so that a strength of the magnetic field at a location of the sensor varies as a function of an angular position of the rotating target relative to the sensor.

5. The method of claim 1, wherein the rotating target is arranged so that a gap between the sensor and the rotating target varies as a function of an angular position of the rotating target relative to the sensor.

6. The method of claim 1, wherein the rotating target has a round shape, the round shape having plurality of different radii, each of the radii originating at a center of the rotating target and ending at an edge of the rotating target, each of the radii being associated with a respective angular coordinate within a coordinate framework of the rotating target, each of the radii having a length that is a function of the radius's respective angular coordinate.

7. The method of claim 1, further comprising, calibrating the sensor when the sensor is turned on, the calibrating including identifying the plurality of peak-to-peak values of the signal and generating the map based on the signal.

8. The method of claim 1, further comprising:
detecting whether an abrupt change of a gap between the sensor and the rotating target has occurred based on a difference between the current angular position of the sensor and an expected angular position of the sensor; and
updating the map when the abrupt change of the gap is detected.

9. A sensor comprising:
one or more magnetic field sensing elements; and
a processing circuitry configured to:
receive a signal that is generated at least in part by the one or more magnetic field sensing elements in response to a magnetic field associated with a rotating target;
detect a current peak-to-peak value of the signal;
identify a current angular position of the rotating target relative to the sensor based on: (i) the current peak-to-peak value and (ii) a map that maps each of a plurality of peak-to-peak values of the signal to a different respective angular position of the rotating target; and
set a value of an output signal based on the current angular position of the rotating target.

10. The sensor of claim 9, wherein any of the one or more magnetic field sensing elements includes at least one of a Hall element, a giant magnetoresistor (GMR), or a tunnel magnetoresistor (TMR).

11. The sensor of claim 9, wherein the map includes at least one of:
an equation that maps each of the plurality of peak-to-peak values of the signal to a different respective angular position of the rotating target,
a lookup table that maps each of the plurality of peak-to-peak values of the signal to a different respective angular position of the rotating target, or
logic that maps each of the plurality of peak-to-peak values of the signal to a different respective angular position of the rotating target.

12. The sensor of claim 9, wherein the rotating target is arranged so that a strength of the magnetic field at a location of the sensor varies as a function of an angular position of the rotating target relative to the sensor.

13. The sensor of claim 9, wherein the rotating target is arranged so that a gap between the sensor and the rotating target varies as a function of an angular position of the rotating target relative to the sensor.

14. The sensor of claim 9, wherein the rotating target has a round shape, the round shape having plurality of different radii, each of the radii originating at a center of mass of the rotating target and ending at an edge of the rotating target, each of the radii being associated with a respective angular coordinate within a coordinate framework of the rotating target, each of the radii having a length that is proportional to a logarithm of the radius's respective angular coordinate.

15. The sensor of claim 9, further wherein the processing circuitry is further configured to calibrate the sensor when the sensor is turned on, the calibrating including identifying the plurality of peak-to-peak values of the signal and generating the map based on the signal.

16. The sensor of claim 9, wherein the processing circuitry is further configured to:
detect whether an abrupt change of a gap between the sensor and the rotating target has occurred based on a difference between the current angular position of the sensor and an expected angular position of the sensor; and
update the map when the abrupt change of the gap is detected.

17. The sensor of claim 9, further comprising a temperature sensing element, wherein the processing circuitry is configured to perform temperature compensation of the signal based on a temperature signal that is generated by the temperature sensing element.

18. The sensor of claim 9, wherein the processing circuitry is further configured to:
detect that the rotating target has stopped rotating;
detect that the rotating target has resumed rotating; and
in response to detecting that the rotating target has resumed rotating: detect whether an abrupt change of a gap between the sensor and the rotating target has occurred, and update the map when the abrupt change of the gap is detected.

19. The sensor of claim 9, wherein the rotating target is arranged so that peak-to-peak values of the signal change with the angular position of the rotating target.

20. The sensor of claim 9, wherein the rotating target includes a ferromagnetic target.

21. A non-transitory computer-readable medium that is arranged to store one or more instructions, which, when executed by a processing circuitry, cause the processing circuitry to perform the operations of:
receiving a signal that is generated at least in part by a one or more magnetic field sensing elements in response to a magnetic field associated with a rotating target, the one or more magnetic field sensing elements being part of a sensor;
detecting a current peak-to-peak value of the signal; and
identifying a current angular position of the rotating target relative to the sensor based on: (i) the current peak-to-peak value and (ii) a map that maps each of a plurality of peak-to-peak values of the signal to a different respective angular position of the rotating target.

22. The non-transitory computer-readable medium of claim 21, wherein the one or more instructions, when executed by the processing circuitry, further cause the processing circuitry to perform the operation of calibrating the sensor when the sensor is turned on, the calibrating including identifying the plurality of peak-to-peak values of the signal and generating the map based on the signal.

23. A method comprising:
receiving a signal that is generated at least in part by a one or more magnetic field sensing elements in response to a magnetic field associated with a rotating target, the rotating target having a feature that changes with target rotation angle, the one or more magnetic field sensing elements being part of a sensor;
detecting a current value of the signal; and
identifying a current angular position of the rotating target relative to the sensor based on: (i) the current value of the signal and (ii) a map that maps each of a plurality of values of the signal to a different respective angular position of the rotating target.

24. The method of claim 23, wherein each of the plurality of values includes a peak-to-peak value, and the maps each of the plurality of peak-to-peak values to a different respective angular position of the target.

25. The method of claim 23, further comprising generating the map that maps each of a plurality of values of the signal to a different respective angular position of the rotating target, the map being generated as a result of executing a calibration procedure.

26. The method of claim 23, wherein the rotating target is arranged so that a strength of the magnetic field at a location of the sensor varies as a function of an angular position of the rotating target relative to the sensor.

27. The method of claim 23, wherein the feature that changes with target rotation angle includes at least one of changing radius, changing tooth size, and changing tooth pitch.

28. A system, comprising:
one or more magnetic field sensing elements that are arranged to generate a signal in response to a magnetic field associated with the rotating target, the rotating target having a feature that changes with target rotation angle, the one or more magnetic field sensing elements being part of a sensor; and
a processing circuitry configured to:
receive a signal that is generated at least in part by the one or more magnetic field sensing elements in response to a magnetic field that is associated with a rotating target;
detect a current value of the signal;
identify a current angular position of the rotating target relative to the sensor based on: (i) the current value and (ii) a map that maps each of a plurality of values of the signal to a different respective angular position of the rotating target; and
set a value of an output signal based on the current angular position of the rotating target,
wherein the rotating target is arranged so that a strength of the magnetic field at a location of the sensor varies as a function of an angular position of the rotating target relative to the sensor.
